(19) United States
(12) Patent Application Publication
(10) Pub. No.: US 2024/0340776 A1
(43) Pub. Date: Oct. 10, 2024

(54) APPARATUS AND METHOD FOR PROVIDING USER PLANE FUNCTION EVENT EXPOSURE SERVICE IN WIRELESS COMMUNICATION SYSTEM

(71) Applicant: ELECTRONICS AND TELECOMMUNICATIONS RESEARCH INSTITUTE, Daejeon (KR)

(72) Inventors: Changki KIM, Daejeon (KR); Jeoung Lak HA, Daejeon (KR); Namseok KO, Daejeon (KR)

(21) Appl. No.: 18/508,618

(22) Filed: Nov. 14, 2023

(30) Foreign Application Priority Data
Apr. 7, 2023 (KR) 10-2023-0046082
Sep. 18, 2023 (KR) 10-2023-0124142

(51) Int. Cl. H04W 48/16; H04W 8/20; H04W 24/02

(52) U.S. Cl. CPC H04W 48/16; H04W 8/20; H04W 24/02

(57) ABSTRACT

Disclosed is an operation method of a session management function (SMF) apparatus for providing a user plane function (UPF) event exposure service in a wireless communication system, the operation method including: obtaining a UPF event exposure service subscription request from a consumer network function (NF) of a UPF event, wherein the UPF event exposure service subscription request includes reporting suggestion information; and providing the reporting suggestion information to a UPF on the basis of the UPF event exposure service subscription request, wherein the reporting suggestion information includes reporting detailed information applied to a result report for the UPF event.

### CROSS REFERENCE TO RELATED APPLICATIONS

The present application claims priority to Korean Patent Application No. 10-2023-0046082, filed 7 Apr. 2023, and Korean Patent Application No. 10-2023-0124142, filed 18 Sep. 2023, the entire contents of which are incorporated herein for all purposes by this reference.

### BACKGROUND OF THE INVENTION

### 1. Field of the Invention

The present disclosure relates to a wireless communication system. More particularly, the present disclosure relates to an apparatus and a method for providing a user plane function (UPF) event exposure service.

### 2. Description of Related Art

3GPP SA2, a main organization of mobile communication standardization, completed stage 2 standardization for 5G system standardization Rel-17 in December 2021. Subsequently, the study for the standardization of Rel-18 began in January 2022, and stage 2 standard specifications were almost completed in the first half of 2023.

Starting from Rel-15, SA2 has been standardizing a control plane of a 5G core network on the basis of a service based architecture (SBA) in principle. Recently, through the standardization processes of Rel-17 and Rel-18, a UPF, which is a user plane function, has been partially included in an SBA architecture of a control plane. In Rel-18, a UPF is limited to providing only an event exposure service using service based interface (SBI) to control plane.

Therefore, the UPF communicates with the control plane through two interfaces: the conventional N4 interface (packet forwarding control protocol, PFCP) and Nupf_EventExposure Service.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a method of reducing a UPF performance degradation caused by multiple event result notifications from the UPF in providing a UPF event exposure service.

According to an embodiment of the present disclosure, there is provided an operation method of a session management function (SMF) apparatus for providing a user plane function (UPF) event exposure service in a wireless communication system, the operation method including: obtaining a UPF event exposure service subscription request from a consumer network function (NF), wherein the UPF event exposure service subscription request includes reporting suggestion information; and providing the reporting suggestion information to a UPF on the basis of the UPF event exposure service subscription request, wherein the reporting suggestion information includes reporting detailed information applied to a result report for the UPF event.

In addition, the reporting detailed information may include at least one of the following: delay tolerance information (reporting urgency information) identified by the UPF on whether reporting delay is tolerable; or valid final reporting time information (reporting window information) for which the result report is valid for the consumer NF, wherein the final reporting time information is applied to the result report for the UPF event.

In addition, the providing of the reporting suggestion information to the UPF on the basis of the UPF event exposure service subscription request may include providing the reporting suggestion information through an SBI interface or an N4 interface.

In addition, the SBI interface may be Nupf_EventExposure, and the N4 interface may be a session report rule (SRR) within a PFCP.

In addition, the obtaining of the UPF event exposure service subscription request from the consumer NF may include obtaining the UPF event exposure service subscription request through an SBI interface.

In addition, the SBI interface may be a Nsmf_EventExposure or Npcf_SMPolicyControl service interface.

In addition, the consumer NF may include at least one of an application function (AF), a network exposure function (NEF), a policy control function (PCF), or a network data analysis function (NWDAF).

In addition, the operation method may further include: regenerating, on the basis of the UPF event exposure service subscription request obtained from the consumer NF, information on an N4 Session ID, a QFI, and an event filter, and reporting suggestion information corresponding to a PDU session of a user equipment(UE); and providing the regenerated information to the UPF through an SBI interface or an N4 interface.

According to an embodiment of the present disclosure, there is provided an operation method of a user plane function (UPF) apparatus for providing a UPF event exposure service in a wireless communication system, the operation method including: obtaining reporting suggestion information from a session management function (SMF), wherein the reporting suggestion information is information included in a UPF event exposure service subscription request provided from a consumer network function (NF); and providing, on the basis of the reporting suggestion information, result reporting information for the subscribed UPF event to the consumer NF, wherein the reporting suggestion information includes reporting detailed information applied to a result report for the subscribed UPF event.

In addition, the reporting detailed information may include at least one of the following: delay tolerance information (reporting urgency information) identified by the UPF on whether reporting delay is tolerable; and valid final reporting time information (reporting window information) applied to the result report for the UPF event.

Herein, the valid final reporting time information may be final time information at which the consumer NF wishes to receive the results of the corresponding UPF event requested, and the UPF shall report the event result to the consumer NF before this time. In addition, the operation method may further include: determining, on the basis of the reporting detailed information, whether the result report for the UPF event is allowed to be delayed; and withholding, depending on a result of determining that the result report is allowed to be delayed, the result report within a valid final time point (reporting window information).

In addition, the providing of the result reporting information of the UPF event to the consumer NF on the basis of the reporting suggestion information may include: determining whether a withheld result report exists; identifying, when the withheld result report exists, whether a first target consumer NF of the withheld result report is the same as a second target consumer NF of the result report; bundling, when the first target consumer NF and the second target consumer NF are the same, respective event results into one bundle and providing it to the consumer NF through a single service operation.

In addition, the obtaining of the reporting suggestion information from the SMW may include obtaining the reporting suggestion information through an SBI interface or an N4 interface.

In addition, the SBI interface may be Nupf_EventExposure, and the N4 interface may be a session report rule (SRR) within a PFCP.

According to an embodiment of the present disclosure, there is provided a user plane function (UPF) apparatus for providing a UPF event exposure service in a wireless communication system, the UPF apparatus including: a transceiver; and at least one controller operably connected to the transceiver, wherein the at least one controller is configured to: obtain reporting suggestion information from a session management function (SMF), wherein the reporting suggestion information is information included in a UPF event exposure service subscription request provided from a consumer network function (NF); and provide, on the basis of the reporting suggestion information, result reporting information to the consumer NF, wherein the reporting suggestion information includes reporting detailed information applied to a result report for the UPF event.

In addition, the reporting detailed information may include at least one of the following: delay tolerance information (reporting urgency information) identified by the UPF on whether reporting delay is tolerable; and valid final reporting time information (reporting window information) for which the result report is valid for the consumer NF, wherein the final reporting time information is applied to the result report for the UPF event.

In addition, the at least one controller is further configured to: determine, on the basis of delay tolerance information, whether the result report corresponding to the UPF event is allowed to be delayed; and withhold, depending on a result of determining that the result report is allowed to be delayed, the result report within a valid final time point (reporting window information).In addition, the at least one controller is further configured to, to provide the result reporting information to the consumer NF on the basis of the reporting suggestion information: determine whether a withheld result report exists; identify, when the withheld result report exists, whether a first target consumer NF of the withheld result report is the same as a second target consumer NF of the result report; and bundle, when the first consumer NF and the second consumer NF are the same, respective event results into one bundle and provide it to the consumer NF through a single service operation.

In addition, the at least one controller is further configured to, to obtain the reporting suggestion information from the SMF, obtain the reporting suggestion information through an SBI interface or an N4 interface.

In addition, the SBI interface may be Nupf_EventExposure, and the N4 interface may be a session report rule (SRR) within a PFCP.

According to the present disclosure, when a consumer NF subscribes to a UPF event, the consumer NF provides reporting suggestion information to the UPF through the SMF, thereby reducing the UPF performance deterioration caused by multiple event result notifications during a UPF event service processing between the consumer NF and the UPF.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows a system architecture in which a user plane function (UPF) of the present disclosure is included in a service based architecture;

FIG. 2 shows a UPF event exposure service procedure through indirect subscription between a consumer NF (e.g., AF, NEF, or NWDAF) and a UPF;

FIG. 3 shows QoS monitoring-related information included in a session reporting rule (SRR) in an N4 interface (PFCP) when subscription to a QoS monitoring event is performed through the N4 interface between an SMF and the UPF in the procedure of FIG. 2.

FIG. 4 shows a UPF event processing procedure between a consumer NF and a UPF according to an embodiment of the present disclosure;

FIG. 5 shows a session report rule (SRR) in an N4 interface (PFCP) including reporting suggestion information according to an embodiment of the present disclosure;

FIG. 6 shows detailed information of reporting suggestion information according to an embodiment of the present disclosure;

FIG. 7 is a flowchart of the operation of an SMF, according to an embodiment of the present disclosure; and

FIG. 8 is a flowchart of the operation of a UPF, according to an embodiment of the present disclosure.

### DETAILED DESCRIPTION OF THE INVENTION

The expression “according to some embodiments” or “according to an embodiment” used throughout the specification does not necessarily indicate the same embodiment.

Some embodiments of the present disclosure may be described into functional block components and various processing steps. Some or all of the functional blocks may be realized as any number of hardware and/or software components performing specific functions. For example, functional blocks of the present disclosure may be realized by one or more microprocessors or by circuit components for a predetermined function. In addition, for example, the functional blocks of the present disclosure may be realized in various programing or scripting languages. The functional blocks may be realized as an algorithm running on one or more processors. In addition, the present disclosure may employ conventional techniques for electronic environment setting, signal processing, and/or data processing. The terms “mechanism”, “element”, “means”, and “component” may be widely used, and are not limited to mechanical and physical components.

Furthermore, connecting lines or connecting members between constituent elements shown in the drawings are merely illustrative of functional connections and/or physical or circuit connections. Connections between constituent elements may be represented by various alternative or additional functional connections, physical connections, or circuit connections in a practical device.

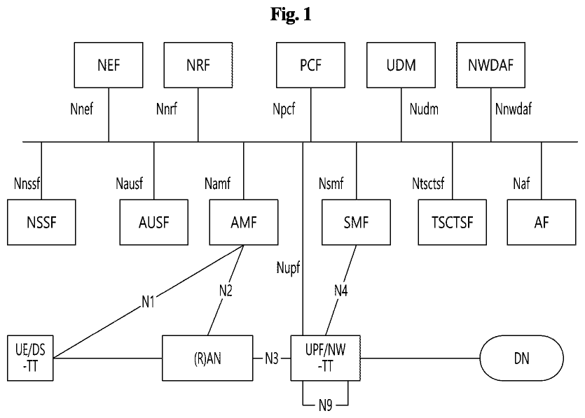

FIG. 1 shows a system architecture in which a user plane function (UPF) of the present disclosure is included in a service based architecture.

Referring to FIG. 1, it can be seen that in addition to a conventional N4 interface as an interface to an SMF, the UPF is included in a control plane SBA architecture though Nupf SBI interface.

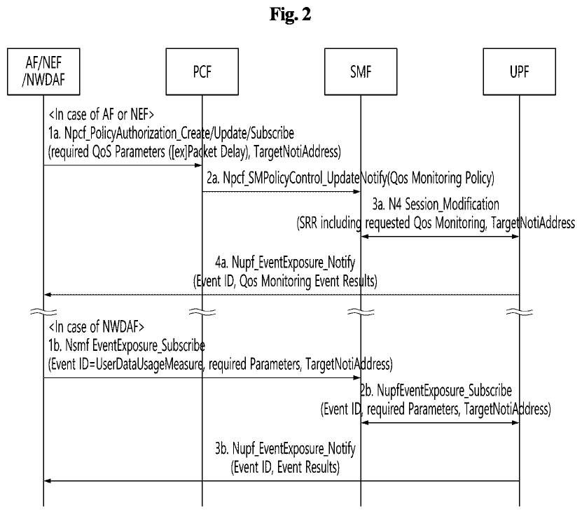

FIG. 2 shows a UPF event exposure service procedure through indirect subscription between a consumer NF (e.g., an AF, an NEF, or an NWDAF) and a UPF.

Specifically, a UPF event exposure service procedure through indirect subscription between a consumer NF and a UPF shown in FIG. 2 may be defined in TS23.502 (V18.1.1). Depending on the type of the consumer NF and the Event, the procedure may be slightly different.

Referring to FIG. 2, UPF event subscription may be made through an SMF, but depending on a type of an event to be subscribed, the interfaces used between the SMF and the UPF may be divided into an N4 interface and an SBI interface. A rough description of the procedure is as follows.

First, the AF or the NEF, which is a consumer NF, may subscribe (1a-3a) to the UPF for a QoS monitoring event through the PCF and the SMF. Herein, the consumer NF may perform transmission with request information for QoS monitoring event and notification target address information for direct notification of event result. The SMF may include the information in the session report rule (SRR) of the N4 (PFCP) and transmit it to the UPF. When the event is detected, the UPF may directly transmit the event result to a notification target consumer NF through the Nupf SBI interface.

In the meantime, the NWDAF, which is a consumer NF, may subscribe (1b-2b) to the UPF for a UserDataUsageMeasure event through the SW. Herein, the consumer NF may perform transmission with request information for the event and a notification target address for direct notification of event result. The SMF may transmit the information to the UPF as an input parameter of a Nupf_EventExposure_Subscribe service operation. When the event is detected, the UPF may directly transmit the event result to a notification target consumer NF through the Nupf SBI interface.

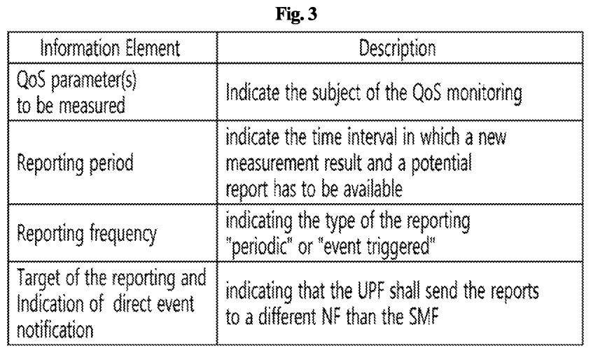

FIG. 3 shows QoS monitoring-related information included in the session reporting rule (SRR) in the N4 interface (PFCP) when subscription to a QoS monitoring event is performed through the N4 interface between the SMF and the UPF in the procedure of FIG. 2.

Referring to FIG. 3, SRR information related to QoS monitoring is described for each information element as follows.

Specifically, the information elements include QoS parameter(s) to be measured, reporting period, reporting frequency, and target of the reporting and indication of direct event notification.

In addition, the QoS parameter(s) to be measured may indicate a subject of QoS monitoring. The reporting period may indicate the time interval in which a new measurement result and a potential report are available. The reporting frequency may indicate the type of periodic or event triggered reporting. The target of the reporting and indication of direct event notification may indicate that the UPF should transmit a report to an NF rather than the SMF.

In general, for every UPF event requested from a consumer NF to the UPF, a result report for the event may be directly transmitted to the consumer NE. However, when multiple various events are subscribed by the same consumer NF, the UPF may cause performance degradation due to multiple notifications of event results. This may not be consistent with the recommendation in SA2 Rel-18 on design in which existing UPF performance is not affected as much as possible while the UPF enhancement for exposure and SBA (UPEAS) standard is added.

Accordingly, in order to solve this problem, the present disclosure provides a method in which when a consumer NF (e.g., an AF, an NEF, or an NWDAF) performs indirect UPF subscription to an UPF event, additional information of reporting suggestion information is provided and the UPF bundles event result notifications transmitted to the same notification target consumer NF into one bundle and transmits it through a single event notification service operation, thereby reducing performance degradation of the UPF.

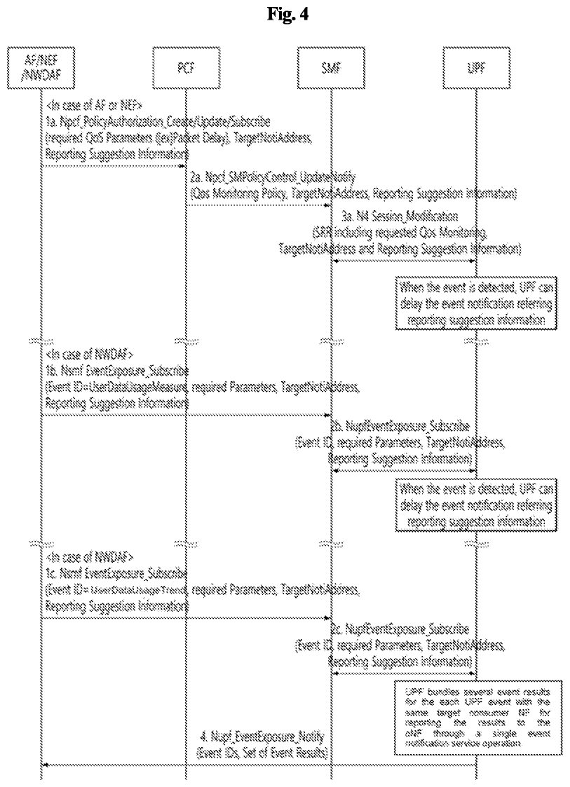

FIG. 4 shows a UPF event processing procedure between a consumer NF and a UPF according to an embodiment of the present disclosure.

The consumer NF subscribes to the UPF for different UPF events through an SMF, and the UPF may transmit, to the consumer NF, event result notifications fewer than the number of events subscribed by the same consumer NE. A rough description of the procedure is as follows.

Referring to FIG. 4, first, the AF or the NEF, which is a consumer NF, may subscribe (1a-3a) to the UPF for a QoS monitoring event through the PCF and the SMF. Herein, the consumer NF may perform transmission with reporting suggestion information in addition to request information for QoS monitoring event and a notification target address for direct notification. The SMF may include the information in the session report rule (SRR) of the N4 (PFCP) and transmit it to the UPF. The UPF recognizes that delay is tolerable by checking reporting delay tolerance information (reporting urgency information) included in the reporting suggestion information of the event. Then, the UPF does not immediately transmit the event result to a notification target consumer NF when the event is detected, and may postpone or withhold a result report within valid final reporting time information (reporting time window) included in the reporting suggestion information.

In the meantime, the NWDAF, which is a consumer NF, may subscribe (1b-2b) to the UPF for a UserDataUsageMeasure event through the SMF. Herein, the consumer NF may perform transmission with reporting suggestion information in addition to request information related to the event and a notification target address for direct notification. The SMF may transmit the information to the UPF as an input parameter of a Nupf_EventExposure_Subscribe service operation. The UPF recognizes that delay is tolerable by checking reporting delay tolerance information (reporting urgency information) included in the reporting suggestion information of the event. Then, the UPF does not immediately transmit the event result to a notification target consumer NF when the event is detected, and may postpone or withhold a result report within valid final reporting time information (reporting time window) included in the reporting suggestion information.

In addition, the NWDAF, which is a consumer NF, may subscribe (1c-2c) to the UPF for a UserDataUsageTrend event through the SMF. Herein, the Consumer NF may perform transmission with reporting suggestion information in addition to request information (required parameters) related to the event and a notification target address for direct notification. The SMF may transmit the information to the UPF as an input parameter of a Nupf_EventExposure_Subscribe service operation.

The UPF may find that an event result notification of the same notification target address has been postponed, and may bundle event result notifications into one bundle to transmit it through a single event notification service operation (step 4). According to the above example, two or more event results in which the consumer NF is the NWDAF may be transmitted through one Nupf_EventExposure_Notifiy service operation.

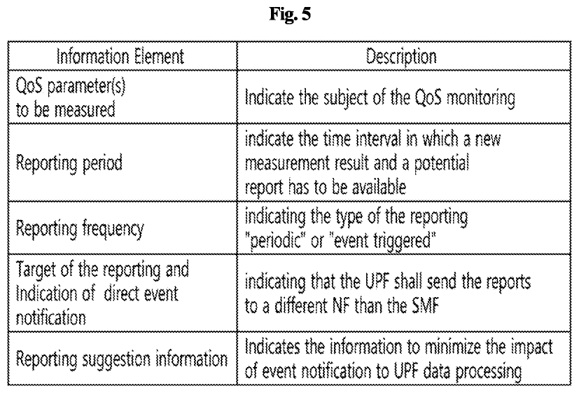

FIG. 5 shows a session report rule (SRR) in an N4 PFCP including reporting suggestion information according to an embodiment of the present disclosure. This may include reporting suggestion information in addition to the QoS monitoring-related rule information and information for direct notification of FIG. 3.

The following illustrates Nsmf_EvenExposure_Subscribe and Nupf_EvenExposure_Subscribe service operations that include reporting suggestion information according to an embodiment of the present disclosure. The reporting suggestion information may be included in the input parameter of each service operation.

Specifically, a Nsmf_EventExposure_subscribe service operation is as follows.
Service operation name: Nsmf_EventExposure_Subscribe.

Input, Required: NF ID, Target of Event Reporting as defined in clause 5.2.8.3.1, (set of) Event ID(s) defined in clause 5.2.8.3.1, Notification Target Address (+ Notification Correlation ID), Event Reporting Information defined in Table 4.15.1-1.

Input, Optional: Event Filter(s) associated with each Event ID; Event Filter(s) are defined in clause 5.2.8.3.1, Subscription Correlation ID (in the case of modification of the event subscription), Expiry time, DNN, S-NSSAI, DNAI, UPFId, UPF event exposure information (Type of measurement, granularity of measurement, etc., associated with the UPF Event IDs as described in clause 4.15.4.5). Reporting suggestion information.

Specifically, a Nupf_EventExposure_subscribe service operation is as follows.
Service operation name: Nupf_EventExposure_Subscribe

Input, Required: NF ID, Target of Event Reporting, (set of) Event ID(s) defined in clause 5.2.26.2.1, Notification Target Address (+ Notification Correlation ID), Event Reporting Information defined in Table 4.15.1-1.

Input, Optional: Subscription Correlation ID (in the case of modification of the event subscription), Expiry time, DNN, S-NSSAI, Application ID(s), traffic filtering information, Type of measurement, granularity of measurement, Reporting suggestion information.

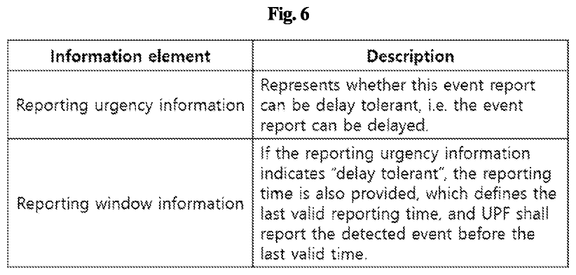

FIG. 6 shows detailed information of reporting suggestion information according to an embodiment of the present disclosure.

Referring to FIG. 6, the reporting suggestion information may include at least one of reporting delay tolerance information (reporting urgency information) or valid final reporting time information (reporting window information). The reporting delay tolerance information may be information that a result report for the event can be delayed. The valid final reporting time information may indicate final time information at which the consumer NF wishes to receive the results of the corresponding UPF event requested. The UPF shall report the event result to the consumer NF before this time.

More specifically, the reporting delay tolerance information may indicate whether delay of reporting the event is allowed, that is, whether event reporting can be delayed. When the reporting delay tolerance information indicates “delay tolerant”, a final reporting time defining a valid final reporting time is provided and the UPF may report an event detected before the last valid final reporting time.

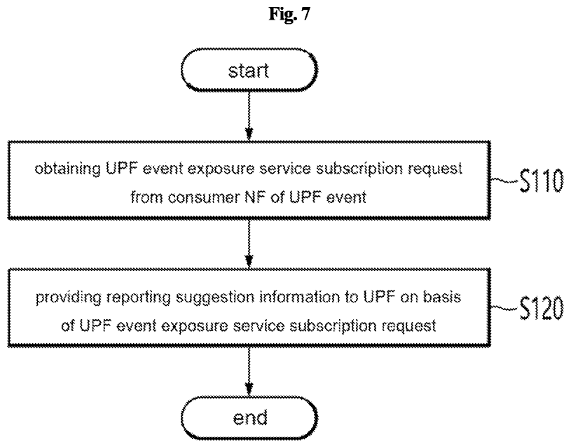

FIG. 7 is a flowchart of the operation of an SMF, according to an embodiment of the present disclosure.

In step S110, the SMF may obtain a UPF event exposure service subscription request from a consumer network function (NF) of an UPF event.

Herein, the UPF event exposure service subscription request may include reporting suggestion information. In addition, the SMF may obtain the UPF event exposure service subscription request through an SBI interface. In addition, the SBI interface may be a Nsmf_EventExposure or Npcf_SMPolicyControl service interface.

In addition, the consumer NF may be at least one of an application function (AF), a network exposure function (NEF), a policy control function (PCF), or a network data analysis function (NWDAF).

In step S120, the SMF may provide, on the basis of the UPF event exposure service subscription request, the reporting suggestion information to a UPF.

Herein, the reporting suggestion information may include reporting detailed information that is applied to a result report for the UPF event.

In addition, the reporting detailed information may include at least one of delay tolerance information identified by the UPF on whether delay is tolerable or valid final reporting time information applied to a result report for the UPF event.

In an embodiment, the SMF may provide, on the basis of the UPF event exposure service subscription request, the reporting suggestion information to the UPF, and may provide the reporting suggestion information through an SBI interface or an N4 interface.

Herein, the SBI interface may be Nupf_EventExposure, and the N4 interface may be a session report rule (SRR) within a PFCP.

In an embodiment, the SMF may regenerate, on the basis of the UPF event exposure service subscription request obtained from the consumer NF, information on an N4 Session ID, a QFI, and an event filter, and reporting suggestion information corresponding to a PDU session of a user equipment (UE), and may provide the regenerated information through an SBI interface or an N4 interface.

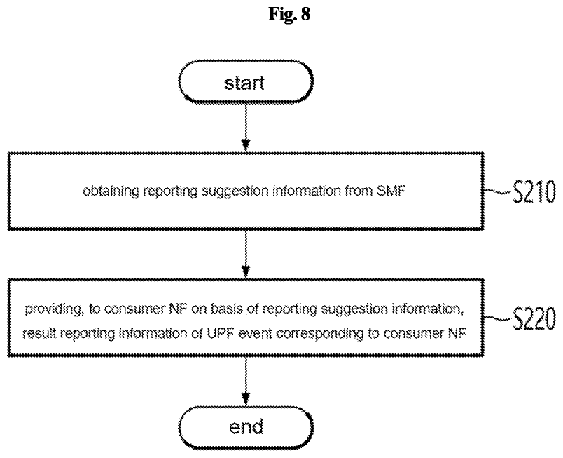

FIG. 8 is a flowchart of the operation of a UPF, according to an embodiment of the present disclosure.

An operation method of a user plane function (UPF) apparatus for providing a UPF event exposure service in a wireless communication system is as follows.

In step S210, the UPF obtains reporting suggestion information from a session management function (SMF).

Herein, the reporting suggestion information may be information included in a UPF event exposure service subscription request provided from a consumer network function (NF) of a UPF event.

In step S220, the UPF may provide, on the basis of the reporting suggestion information, result reporting information of the UPF event to the consumer NE.

Herein, the reporting suggestion information may include reporting detailed information that is applied to a result report for the UPF event. In addition, the reporting detailed information may include at least one of delay tolerance information identified by the UPF on whether reporting delay is tolerable or valid final reporting time information applied to a result report for the UPF event.

Herein, the valid final reporting time information may indicate valid final time information at which the consumer NF wishes to receive the results of the corresponding UPF event requested, and the UPF shall report the event result to the consumer NF before this time. In an embodiment, the UPF may determine, on the basis of delay information, whether a result report corresponding to a UPF event is allowed to be delayed. Depending on a result of determining that the result report is allowed to be delayed, the event result report may be withheld within the final time point (reporting window information) at which the result report is valid.

More specifically, in step S220, the UPF determines whether a withheld result report exists. When a withheld result report exists, it is identified whether a first target consumer NF of the withheld result report is the same as a second target consumer NF t of the result report for the UPF.

When the first target consumer NF and the second target consumer NF are the same, respective event results may be bundled into one bundle and it may be provided to the consumer NF through a single service operation.

In an embodiment, the UPF may obtain the reporting suggestion information from the SMF through an SBI interface or an N4 interface.

Herein, the SBI interface may be Nupf_EventExposure, and the N4 interface (PFCP) may be a session report rule (SRR).

Specific embodiments for implementing the present disclosure have been described. The present disclosure may include the above-described embodiments as well as embodiments simply changed in design or easily changed. In addition, the present disclosure may also include techniques easily modified using the embodiments and implemented. Therefore, the scope of the present disclosure should not be defined as being limited to the embodiments, but should be defined by the appended claims and equivalents thereof.

What is claimed is:

1. An operation method of apparatus of a session management function (SMF) for providing a user plane function (UPF) event exposure service in a wireless communication system, the operation method comprising:
obtaining a UPF event exposure service subscription request from a consumer network function (NF) of a UPF event, wherein the UPF event exposure service subscription request includes reporting suggestion information; and
providing the reporting suggestion information to a UPF on the basis of the UPF event exposure service subscription request,
wherein the reporting suggestion information includes reporting detailed information corresponding to a result report for the UPF event.

2. The operation method of claim 1, wherein the reporting detailed information includes at least one of the following:
delay tolerance information (reporting urgency information) identified by the UPF on whether reporting delay is tolerable; or
valid final reporting time information (reporting window information) applied to the result report for the UPF event.

3. The operation method of claim 1, wherein the providing of the reporting suggestion information to the UPF on the basis of the UPF event exposure service subscription request comprises providing the reporting suggestion information through an SBI interface or an N4 interface.

4. The operation method of claim 3, wherein the SBI interface is Nupf_EventExposure, and the N4 interface is a session report rule (SRR) within a packet forwarding control protocol (PFCP).

5. The operation method of claim 1, wherein the obtaining of the UPF event exposure service subscription request from the consumer NF of the UPF event comprises
obtaining the UPF event exposure service subscription request through an SBI interface.

6. The operation method of claim 5, wherein the SBI interface is a Nsmf_EventExposure or Npcf_SMPolicyControl service interface.

7. The operation method of claim 1, wherein the consumer NF includes at least one of an application function (AF), a network exposure function (NEF), a policy control function (PCF), a network data analysis function (NWDAF).

8. The operation method of claim 1, further comprising:
regenerating, on the basis of the UPF event exposure service subscription request obtained from the consumer NF, information on an N4 Session ID, a QFI, and an event filter, and reporting suggestion information corresponding to a PDU session of a user equipment; and
providing the regenerated information to the UPF through an SBI interface or an N4 interface.

9. An operation method of an apparatus of user plane function (UPF) for providing a UPF event exposure service in a wireless communication system, the operation method comprising:
obtaining reporting suggestion information from a session management function (SMF), wherein the reporting suggestion information is information included in a UPF event exposure service subscription request provided from a consumer network function (NF); and
providing, on the basis of the reporting suggestion information, result reporting information of the UPF event to the consumer NF,
wherein the reporting suggestion information includes reporting detailed information corresponding to a result report for the UPF event.

10. The operation method of claim 9, wherein the reporting detailed information includes at least one of the following:
delay tolerance information (reporting urgency information) identified by the UPF on whether reporting delay is tolerable; or
valid final reporting time information (reporting window information) applied to the result report for the UPF event.

11. The operation method of claim 9, further comprising:
determining, on the basis of the reporting detailed information, whether the result report corresponding to the UPF event is allowed to be delayed; and
withholding, depending on a result of determining that the result report is allowed to be delayed, the result report within a valid final reporting time point.

12. The operation method of claim 11, wherein the providing of the result reporting information of the UPF event to the consumer NF on the basis of the reporting suggestion information comprises:
determining whether a withheld result report exists;
identifying, when the withheld result report exists, whether the first target consumer NF of the withheld result report is the same as the second target consumer NF of the result report for the UPF event; and
bundling, when the first target consumer NF and the second target consumer NF are the same, respective event result notifications into a bundle and providing it to the consumer NF through a single service operation.

13. The operation method of claim 9, wherein the obtaining of the reporting suggestion information from the SMF comprises
obtaining the reporting suggestion information through an SBI interface or an N4 interface.

14. The operation method of claim 13, wherein the SBI interface is Nupf_EventExposure, and the N4 interface is a session report rule (SRR).

15. A user plane function (UPF) apparatus for providing a UPF event exposure service in a wireless communication system, the UPF apparatus comprising:
a transceiver; and
at least one controller operably connected to the transceiver,
wherein the at least one controller is configured to:
obtain reporting suggestion information from a session management function (SMF), wherein the reporting suggestion information is information included in a UPF event exposure service subscription request provided from a consumer network function (NF); and
provide, on the basis of the reporting suggestion information, result reporting information of the UPF event to the consumer NF,
wherein the reporting suggestion information includes reporting detailed information applied to a result report for the UPF event.

16. The UPF apparatus of claim 15, wherein the reporting detailed information includes at least one of the following:
delay tolerance information (reporting urgency information) identified by the UPF on whether reporting delay is tolerable; or
valid final reporting time information (reporting window information) applied to the result report for the UPF event.

17. The UPF apparatus of claim 15, wherein the at least one controller is further configured to determine, on the basis of the reporting detailed information, whether the result report corresponding to the UPF event is allowed to be delayed, and
withhold, depending on a result of determining that the result report is allowed to be delayed, the result report within a valid final reporting time.

18. The UPF apparatus of claim 17, wherein the at least one controller is further configured to, to provide the result reporting information of the UPF event to the consumer NF on the basis of the reporting suggestion information,
determine whether a withheld result report exists,
identify, when the withheld result report exists, whether first target consumer NF of the withheld result report is the same as the second target consumer NF of the result report for the UPF event, and
bundle, when the first consumer target NF and the second target consumer NF are the same, respective event results into one bundle and provide it to the consumer NF through a single service operation.

19. The UPF apparatus of claim 15, wherein the at least one controller is further configured to, to obtain the reporting suggestion information from the SMF,
obtain the reporting suggestion information through an SBI interface or an N4 interface.

20. The UPF apparatus of claim 19, wherein the SBI interface is Nupf_EventExposure, and the N4 interface is a session report rule (SRR).
